(19) United States
(12) Patent Application Publication
(10) Pub. No.: US 2008/0028665 A1
(43) Pub. Date: Feb. 7, 2008

(54) Fishing rod handle

(76) Inventor: Alan J. Barrett, White Lake, MI (US)

Correspondence Address: RAGGIO & DINNIN, P.C., 2701 CAMBRIDGE COURT, STE. 410, AUBURN HILLS, MI, 48326, US

(21) Appl. No.: 11/891,956

(22) Filed: Aug. 14, 2007

Related U.S. Application Data
(62) Division of application No. 10/976,099, filed on Oct. 27, 2004.

(51) Int. Cl. A01K 87/08

(52) U.S. Cl. 43/23

(57) ABSTRACT

A fishing rod handle including a base section and a curved section wherein said curved section together with said base section form a wrist size opening such that the fishing rod is capable of hanging from a wrist.

This is a divisional of application. Ser. No. 10/976,099, filed Oct. 27, 2004

### TECHNICAL FIELD

This invention relates generally to an improved fishing rod handle and more particularly to a hook shaped fishing rod handle for improving the grip and general ergonomic features of a fishing rod.

### BACKGROUND OF THE INVENTION

The popularity of fishing as a past time and sport is ever increasing. With the increase in popularity, more functional and ergonomic equipment is the goal of every fisherman. Fishing rod handles have in some fashion remained unchanged since the very early days of fishing. The fishing rod handle has historically been a handle which is in the same plane and in a straight line with the rod itself. This comes from the very early fishing rods which were essentially pieces or portions of tree limbs.

Fishing technology has improved over the very early fishing equipment. U.S. Pat. No. 4,860,483 discloses a fishing rod with a “c” or “u” shaped handle portion, a reel support mounted to said C or U-shaped section, and a rod passing through the two ends of said C or U-shaped section.

U.S. Pat. No. 6,705,041 discloses a fishing rod with a carrying handle fastened to the fishing rod to facilitate lifting and handling of the fishing rod comprising a hand grip shaped and dimensioned for comfortable gripping in the hand, a clamp e.g. in the form of a diametrically split ring or split collar, which can be clamped securely to the fishing rod by tightening screw fasteners, and an arm which connects the clamp to the hand grip. The handle is secured to the fishing rod so that the hand grip extends alongside the rod below the fishing reel seat.

A need for an improved fishing rod handle having a hook shaped rod handle for improving the grip and general ergonomic features of a fishing rod has developed in the sport of fishing.

### SUMMARY OF THE INVENTION

The fishing rod handle of the present invention has been developed to meet the need for an improved fishing rod handle which is ergonomically friendly, and improves the functionality of the fishing rod handle by allowing use as a hanging means and improves casting capability.

Accordingly, it is an object of the present invention to provide a fishing rod handle for use with a fishing rod, the fishing rod handle comprising a base section and a curved section wherein the curved section together with the base section forms a wrist size opening such that the fishing rod is capable of hanging from the fisherman's wrist.

Another object of the present invention is to provide an improved fishing rod handle that can be hung over a fisherman's wrist when the fisherman is attending to other actions such as addressing a fishing line, tying knots or removing a fish from the hook.

A further object of the present invention is to provide an improved fishing rod handle with a hook section to ease the stress in hard reeling when the rod handle is pressed into the fisherman's midsection.

It is a still further object of the present invention to provide an improved fishing rod handle with a hook section to increase the grip comfort in handling the rod handle.

It is a yet still further object of the present invention to provide an improved fishing rod handle with a hook section to decrease the opportunity for the fisherman to lose grip of the fishing rod handle while casting.

It is yet another object of the present invention to provide an improved fishing rod handle with a hook section to protect against accidental dropping of the fishing rod overboard by placing the hook section around the fisherman's wrist.

A more specific object of the present invention is to provide a fishing rod handle for use with a fishing rod, where the fishing rod handle includes a base section having a circular cross section and a curved section where the curved section together with the base section forms a wrist size opening such that the fishing rod is capable of hanging from a wrist and the curved section has a middle portion and an end portion, the end portion having a first cross sectional shape and the middle portion having a second cross sectional shape wherein the end portion cross sectional shape is larger than the middle portion cross sectional shape and the end portion cross sectional shape forms a flat comfort surface on the curved section.

Another more specific object of the present invention is to provide a fishing rod handle for use with a fishing rod, the fishing rod handle including a universally adjustable flexible core, the universally adjustable core having a range of movement capable of forming a wrist size opening such that the fishing rod is capable of hanging from a wrist and an outer shell covering said universally adjustable flexible core such that the rod handle can be adjusted to fit the wrist size of the fisherman.

Still another more specific object of the present invention is to provide the fishing rod handle including a universally adjustable flexible core such that the rod handle can be infinitely adjusted to any shape useful when fishing such as hook shapes for use in hooking the rod handle over a stationary object for storage.

Yet another more specific object of the present invention is to provide a fishing rod handle with a hook shape including an inerrable weight at one end to assist in support of the fishing rod in the casting motions.

The above objects and other objects, features and advantages of the present invention are readily apparent from the following detailed description of the best mode for carrying out the invention to be taken in connection with the accompanying drawings.

### BRIEF DESCRIPTION OF THE DRAWINGS

FIG. 1 is a perspective view of the fishing rod handle of the present invention.

FIG. 2 is a cross sectional view of the fishing rod of the present invention taken along line A-A of FIG. 1.

FIG. 3 is a perspective view of an alternative fishing rod handle of the present invention.

FIG. 4 is a cross sectional view of the fishing rod of FIG. 3 taken along line B-B of FIG. 3.

FIG. 5 is a perspective view of another alternative fishing rod handle of the present invention.

FIG. 6 is a perspective view of yet another alternative fishing rod handle of the present invention.

FIG. 7 is a perspective view of still yet another alternative fishing rod handle of the present invention.

FIG. 8 is a perspective view of the alternative fishing rod handle of FIG. 7 showing movement of the handle in different planes.

FIG. 8a is a cross sectional view of a solid core fishing rod handle of the present invention.

FIG. 8b is a cross sectional view of a hollow core fishing rod handle of the present invention.

FIG. 8c is a cross sectional view of another hollow core fishing rod handle of the present invention.

FIG. 9 is a perspective view of still yet another alternative fishing rod handle of the present invention.

FIG. 10 is a perspective view of still yet another alternative fishing rod handle of the present invention.

FIG. 11 is a perspective view of still yet another alternative fishing rod handle of the present invention.

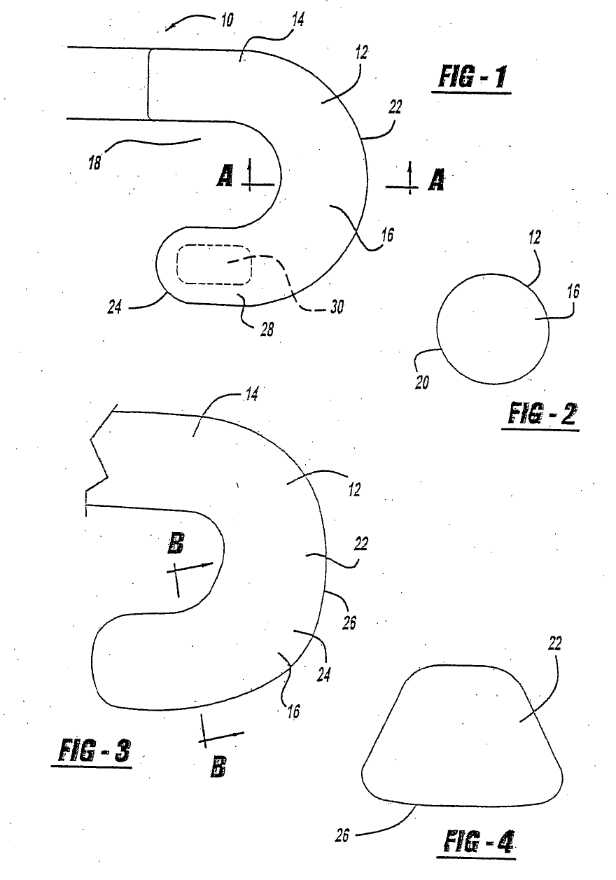

### DETAILED DESCRIPTION OF THE INVENTION

Referring now to FIG. 1, there is shown generally, a fishing rod 10 including a fishing rod handle 12. The fishing rod handle 12 has a base section 14 and a curved section 16. The curved section 16 together with the base section 14 form a wrist size opening 18 such that the fishing rod is capable of hanging from a wrist (not shown). The wrist size opening should be large enough to accept a fisherman's wrist. The wrist size opening 18 allows the rod to be hung over a fisherman's wrist when the fisherman is attending to other actions such as addressing a fishing line, tying knots or removing a fish from the hook. This generally improves the fisherman's ability to control the rod during these other actions. The curved section 16 also protects the fisherman from an accidental dropping or loss of the rod, when the rod is hung over the fisherman's wrist.

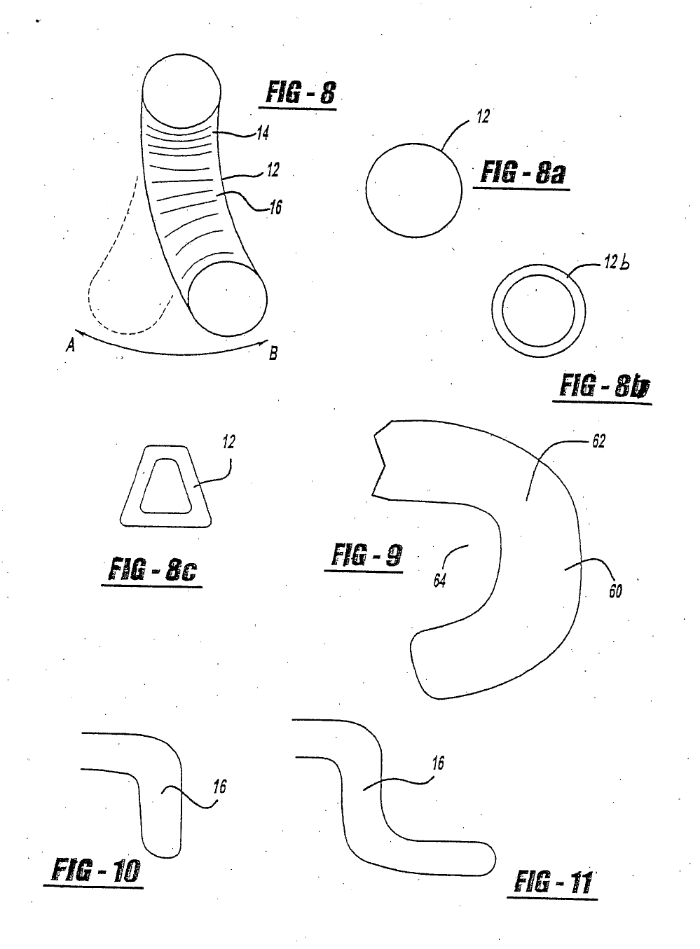

The fishing rod handle of the present invention may be manufactured from any material which allows for the formation of the curved section 16 and base section 14. Materials such as plastics, wood, aluminum and other metals is contemplated by the present invention. Curved section 16, in the preferred embodiment, forms a full semi-circle in relation to the base section 14. Curved section 16 may be less than, equal to or larger than a full semi-circle. This semi-circular shape provides for an ease of handling, gripping and hanging of the fishing rod 10. The present invention contemplates many other curved shapes for the curved section 16 other than semi-circle or “c” shapes such as “1” and reverse “s” shapes as shown in FIGS. 10 and 11.

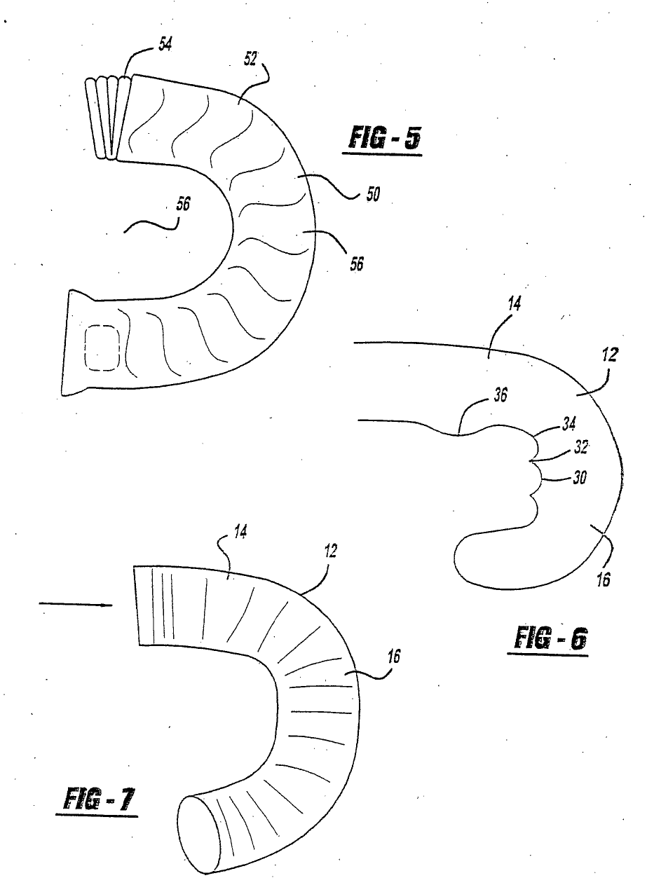

In an alternative embodiment of the present invention shown in FIGS. 7 and 8, curved section 16 forms a full semi-circle in relation to base section 14 but is defined in a different plane than base portion 14. As shown, base portion 14 is defined in one plane B and the curved section 16 moves out in a different plane as illustrated by arrow A. Curved section 16, in this embodiment provides for a different type of handling and gripping but still allows for hooking the rod handle 12 to obtain the general benefits described herein. FIG. 8a illustrates a solid core fishing rod handle 12, 8b illustrates a hollow core fishing rod handle 12b and 8c illustrates a non-circular cross section hollow core.

In one embodiment of the present invention, the curved section 16 has a circular cross section 20. In another embodiment, fishing rod handle 12 has a curved section 16 as described above, a middle portion 22 and an end portion 24. The end portion 24 has a first cross sectional shape and the middle portion has a second cross sectional shape as shown in FIG. 4. The middle portion 22 of the curved section 16, in an alternative embodiment includes a comfort surface 26. This comfort surface 26, as shown in FIG. 4, is wider at one end to allow for greater comfort when the fisherman is using the fishing rod. More specifically, the overall curved section 12 by itself and the addition of the comfort surface 26 eases the stress in hard reeling when the rod handle is pressed into the fisherman's midsection.

In yet another alternative embodiment, curved section 12 includes a weighted portion 28. The weighted portion is provided in the end portion 24. The weighted portion may be the addition of a metal weight 30 as shown in FIG. 1 or may be some other method of an addition of weight. Methods such as adding weight to the outside of the curved section 12 at the end by, screwing, gluing, taping or affixing a weight to the end section is contemplated by the present invention. In operation, the addition of weight to the curved section is to assist in casting with the fishing rod.

Referring now to FIG. 6, there is shown another alternative embodiment of the present invention. Curved section 16 includes comfort grooves 30. The comfort grooves 30 are made from raised areas 32 and lowered areas 34. These comfort grooves 30 provides for yet another variation on a feel of the rod handle and its ease of handling, gripping and hanging of the fishing rod 10 while still allowing for hooking the rod handle 12 to obtain the general benefits described herein.

As illustrated in FIG. 5, there is shown still another alternative of the present invention. Fishing rod handle 50 is made from a universally adjustable flexible core 52. The flexible core 52 is manufactured from a coil or springlike winding 54 and an outer casing 56. The flexible core is commonly used for flashlight handle type mechanisms to allow the flashlight to be attached to various articles or held in different manners. In the present invention, universally adjustable flexible core 52 allows a range of movement capable of forming a wrist size opening 56 such that the fishing rod is capable of hanging from a wrist.

As illustrated in FIG. 9, there is shown another alternative embodiment of the present invention. Fishing rod handle 60 includes a malleable base section 62. The malleable base section 62 has a range of movement capable of forming a wrist size opening 64 such that the fishing rod is capable of hanging from a wrist. The fishing rod handle is made from a malleable material such as malleable steel or a hollow metal. The malleable material is rigid enough to allow the fisherman to find and hold the appropriate rod handle shape or design by physical adjustments to the shape.

While the best mode for carrying out the invention has been described in detail, those familiar with the art to which this invention relates will recognize various alternative designs and embodiments for practicing the invention as defined by the following claims.

1. A fishing rod handle for use with a fishing rod, said fishing rod handle comprising:
a base section; and
a curved section wherein said curved section together with said base section form a wrist size opening such that the fishing rod is capable of hanging from a wrist.

2. (canceled)

3. (canceled)

4. (canceled)

5. (canceled)

6. (canceled)

7. (canceled)

8. The fishing rod handle of claim 1 wherein said curved section is defined in a different plane than said base portion.

9. The fishing rod handle of claim 1 wherein said curved section includes comfort grooves.

10. The fishing rod handle of claim 1 wherein said curved section is manufactured from a universally adjustable flexible core.

11. (canceled)

12. (canceled)

13. A fishing rod handle for use with a fishing rod, said fishing rod handle comprising:
a universally adjustable flexible core, said universally adjustable flexible core having a range of movement capable of forming a wrist size opening such that the fishing rod is capable of hanging from a wrist.

14. The fishing rod handle of claim 13 wherein said universally adjustable flexible core includes a weighted portion to assist in the support of said fishing rod.

15. The fishing rod handle of claim 13 further including an outer shell covering said universally adjustable flexible core.

16. A fishing rod handle for use with a fishing rod, said fishing rod handle comprising:
a base section; and
a curved section wherein said curved section together with said base section forms a wrist size opening such that the fishing rod is capable of hanging from a wrist and said curved section has a middle portion and an end portion, said end portion having a first cross sectional shape and said middle portion having a second cross sectional shape wherein said end portion cross sectional shape is larger than said middle portion cross sectional shape and said end portion cross sectional shape forms a flat comfort surface on said curved section.

17. (canceled)

18. (canceled)

19. The fishing rod of claim 16 wherein said curved section is manufactured from a flexible core.

20. (canceled)

21. (canceled)
